(19) United States
(12) Patent Application Publication
(10) Pub. No.: US 2026/0200110 A1
(43) Pub. Date: Jul. 16, 2026

(54) Cutter And Method of Controlling Cutter

(71) Applicant: Samsung Electronics Co., Ltd., Suwon-si (KR)

(72) Inventors: Kyoungsoo Shin, Suwon-si (KR); Jongman Seo, Seoul-si (KR); Myeongwoo Lee, Suwon-si (KR); Taesung Kim, Suwon-si (KR); Sunghu Lee, Seoul-si (KR); Jihye Min, Suwon-si (KR); Sangpil Lee, Suwon-si (KR); Changhoon Lee, Seoul-si (KR)

(73) Assignee: Daemyounggec Co., Ltd., Seoul (KR)

(21) Appl. No.: 19/372,925

(22) Filed: Oct. 29, 2025

(30) Foreign Application Priority Data
Jan. 16, 2025 (KR) 10-2025-0006830
Mar. 26, 2025 (KR) 10-2025-0039043

(51) Int. Cl. B26B 15/00; H02G 1/00

(52) U.S. Cl. CPC B26B 15/00; H02G 1/005

(57) ABSTRACT

A cutter may include a cutting system configured to cut a cable and including a first blade and a second blade that receive a voltage of electrostatic charge applied from the cable, an amplifier circuit configured to amplify a signal of the voltage of electrostatic charge detected by the cutting system, a live-line detection circuit configured to determine, based on the signal amplified by the amplifier circuit, whether the cable is live, a power supply circuit configured to supply power to the cutting system, and a controller configured to, when the cable is determined to be live by the live-line detection circuit, cut off the power supplied to the cutting system.

### CROSS-REFERENCE TO RELATED APPLICATION

This application is based on and claims priority under 35 U.S.C. §119 to Korean Patent Application No. 10-2025-0006830, filed on January 16, 2025 and 10-2025-0039043, filed on March 26, 2025 in the Korean Intellectual Property Office, the disclosures of which are incorporated by reference herein in their entireties.

### BACKGROUND

A cable (electric wire) may refer to a line used to transmit power or an electrical signal. Generally, cables may be classified into bare wires and insulated wires. Among these, a bare wire may refer to a cable that does not have an insulation coating over a conductor, and may be used for special high-voltage transmission cables, trolley lines, etc. An insulated wire may be a cable that has an insulation coating over a conductor to prevent electricity from leaking to the outside, and may be widely used in indoor facilities, etc. In addition, the conductor constituting a cable may include copper having low electrical resistance, and the insulated coat may include rubber, polyethylene, etc. When installing new electrical equipment or repairing or removing existing electrical equipment, work for installing new cables to supply power to the new electrical equipment or work for replacing and removing existing cables that supply power to the existing electrical equipment are desired to be performed together. In this case, prior to performing the work of installing, replacing, or removing cables, a preliminary inspection is desired to be performed to determine whether the cables to be worked on are energized (i.e., live) for the safety of workers or electrical equipment. However, accidents may occur due to, for example, non-compliance with the Standard Operating Procedure (SOP), worker misjudgment, mistaken cutting of cables, etc. To address these problems, electroscopes that inspect whether or not the cables to be worked on are live have been developed. However, it is desired to minimize human and material damage by reducing the probability of accidents to zero.

### SUMMARY

In general, the present disclosure is directed toward a cutter device with improved reliability anda method of controlling a cutter device with improved reliability.

According to some implementations, the present disclosure is directed to a cutter device including a cutting system configured to cut a cable and including a first blade and a second blade that receive a voltage of electrostatic charge applied from the cable, an amplifier circuit configured to amplify a signal for the voltage of electrostatic charge detected by the cutting system, a live-line detection circuit configured to determine, based on the signal amplified by the amplifier circuit, whether the cable is live, a power supply circuit configured to supply power to the cutting system, and a controller configured to, when the cable is determined to be live by the live-line detection circuit, cut off power supplied to the cutting system.

According to some implementations, the present disclosure is directed to a cutter device including a cutting system configured to cut a cable and including a first blade and a second blade that receive a voltage of electrostatic charge applied from the cable, an amplifier circuit configured to amplify a signal for the voltage of electrostatic charge detected by the cutting system, a live-line detection circuit configured to determine, based on the signal amplified by the amplifier circuit, whether the cable is live, a controller configured to cut off power supplied to the cutting system when the cable is determined to be live by the live-line detection circuit, a first main body connected to a lower portion of the cutting system, and a second main body disposed at a lower portion of the first main body and including a power supply circuit, wherein the power supply circuit supplies power to the cutting system and the controller, respectively, and a magnitude of a voltage of power supplied to the controller is less than a magnitude of power supplied to the cutting system.

According to some implementations, the present disclosure is directed to a cutter device including a cutting system configured to cut a cable and including a first blade and a second blade that receive a voltage of electrostatic charge applied from the cable, an amplifier circuit configured to amplify a signal of the voltage of electrostatic charge detected by the cutting system, a live-line detection circuit configured to determine, based on the signal amplified by the amplifier circuit, whether the cable is live, a controller configured to cut off power supplied to the cutting system when the cable is determined to be live by the live-line detection circuit, a first main body connected to a lower portion of the cutting system, a second main body disposed on a lower portion of the first main body and including a power supply circuit, a live-line detection integrated circuit (IC) included in the live-line detection circuit, and a micro control circuit included in the controller, wherein the power supply circuit includes a power separation and decompression circuit configured to supply power to the cutting system and the controller, respectively, and configured to prevent noise generated between the power supply circuit and the controller, wherein the control circuit and the cutting system are each independently connected to the power supply circuit, the power separation and decompression circuit is composed of a switch circuit, a battery circuit, and a power separation circuit that are electrically connected to each other, and a magnitude of a first voltage of the battery circuit operated by the switch circuit is greater than a magnitude of a second voltage transmitted from the battery circuit to the power separation circuit, and each of the live-line detection IC and the micro control circuit is electrically connected to the power separation circuit, and a magnitude of a third voltage transmitted from the power separation circuit to each of the live-line detection IC and the micro control circuit is less than the magnitude of the second voltage.

### BRIEF DESCRIPTION OF THE DRAWINGS

Example implementations will be more clearly understood from the following detailed description, taken in conjunction with the accompanying drawings.

FIG. 1 is a schematic diagram showing examples of external components of a cutter device according to some implementations.

FIG. 2 is a schematic diagram showing examples of internal components of a cutter device according to some implementations.

FIG. 3 is a diagram for explaining an example of an operating state of a cutter device according to some implementations.

FIG. 4 is a diagram for explaining an example of a function of a cutter device according to some implementations.

FIG. 5 is a conceptual diagram showing an example of a process of supplying power to a cutter device according to some implementations.

FIG. 6 is a conceptual diagram showing an example of a process of transmitting a live signal of a cutter device according to some implementations.

FIG. 7 is a conceptual diagram showing an example of a process of receiving a live signal and stopping the operation of a cutting system of a cutter device according to some implementations.

FIG. 8 is a conceptual diagram showing an example of a process of supplying power to a cutter device according to some implementations.

FIG. 9 is a flowchart showing a sequence of an example of a control method of a cutter device according to some implementations.

FIG. 10 is a flowchart showing an example of a control method of a cutter device when detecting a live-line according to some implementations.

FIG. 11 is a flowchart showing an example of a process of supplying power to a cutter device according to some implementations.

### DETAILED DESCRIPTION

Hereinafter, example implementations will be described in detail with reference to the attached drawings.

All examples or example terms are simply used to explain in detail the technical scope of the inventive concept, and the scope of the inventive concept is not limited by the examples or the example terms as long as it is not defined by the claims.

Unless otherwise specifically stated, in the present disclosure, the vertical direction is defined as the Z direction, and the first horizontal direction and the second horizontal direction may each be defined as horizontal directions perpendicular to the Z direction. A first horizontal direction may be referred to as an X direction, and a second horizontal direction may be referred to as a Y direction. The vertical level may denote a height level in the vertical direction (Z direction). A horizontal width may denote a length in the horizontal direction (X direction and/or Y direction), and a vertical length may denote a length in the vertical direction (Z direction).

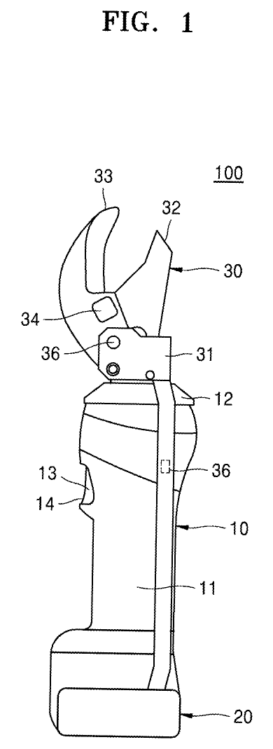

FIG. 1 is a schematic diagram showing examples of external components of a cutter 100 according to some implementations. In FIG. 1, when installing new electrical equipment or repairing or removing existing electrical equipment, the work of installing a new cable to supply power to the new electrical equipment or replacing or removing an existing cable to supply power to the existing electrical equipment must also be performed. In this case, prior to performing the work of installing, replacing, or removing the cable, a process of checking whether the cable is energized (i.e., live) must be performed in advance for the safety of the worker or the electrical equipment.

However, there were problems of safety accidents occurring due to causes such as non-compliance with the management operation regulations (Standard Operating Procedure (SOP)), worker misjudgment, and cable miscutting, etc. To solve these problems, electroscopes that check whether or not the cable to be worked on is live have been developed recently, but additional research is needed to minimize human and material damage by reducing the probability of accident occurrence to zero.

In FIG. 1, a cutter device 100 capable of detecting live-lines may be configured to include a first main body 10, a second main body 20, and a cutting unit (system) 30. If each component is described, the first main body 10 constitutes a body of the cutter device 100 and forms a space where a user may grip the cutter device 100. Specifically, the first main body 10 may be configured by including a body unit (portion) 11, a rotation unit (portion) 12, and a button unit (portion) 13. The body portion 11 may have an appropriate volume so that a user may grip the body portion 11. The rotation portion 12 may enable the cutting system 30 to be described later to rotate. The button portion 13 may be configured to control the operation of the cutting device 30. In addition, a grounding portion 14 may be arranged near the button portion 13. When a user holds the cutter 100, the grounding portion 14 may form a ground by coming into contact with the ground, and when the cutter 100 is operated, the grounding portion 14 may form a closed loop.

The body portion 11 may be arranged between the second main body 20 and the cutting system 30 to form the body of the cutter device 100. The body portion 11 may be formed in a cylindrical shape so that the user may easily hold the body portion 11. However, it is not limited thereto, and the grounding portion 14 may be formed in various shapes that the user may hold, such as a hexahedron or a cone. The rotation portion 12 is arranged between the body portion 11 and the cutting system 30 and, and is fixedly coupled to the cutting system 30, and may rotate the cutting system 30 around the body portion 11. The rotation portion 12 may rotate the cutting system 30 clockwise or counterclockwise with the longitudinal direction of the body portion 11 as an axis.

The button portion 13 may be arranged on a side of the body portion 11. That is, the button portion 13 may be arranged at a position where the worker may easily press the button portion 13 with one of his fingers while holding the body portion 11. The button portion 13 may convert a physical signal according to the worker's pressing into an electrical signal and receive a signal from the worker regarding the operation control of the cutting system 30.

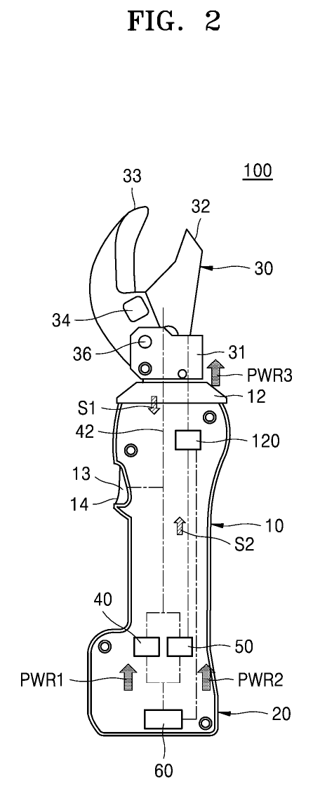

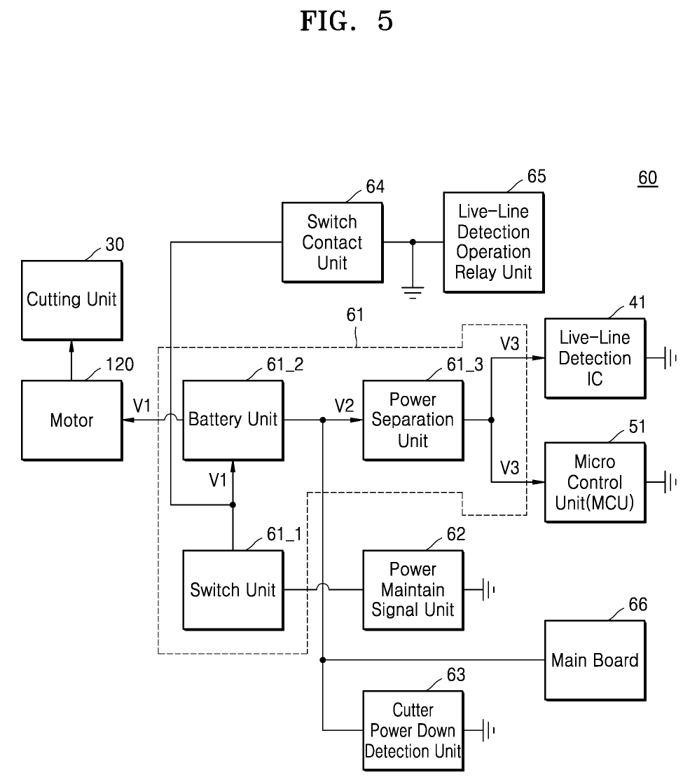

The second main body 20 may be arranged at one end of the first main body 10. Specifically, the second main body 20 may be arranged to face the cutting system 30 with the first main body 10 as the center. The second main body 20 may be electrically connected to the cutting system 30 through the first main body10, and may include a main board for controlling the function of the cutter device 100, a battery for supplying power to each component, etc. A main board 66 may include a controller 50 and a live-line detection circuit 40 described with reference to FIG. 2. A battery circuit 61_2 (refer to FIG. 5) is described in detail with reference to FIG. 5.

The cutting system 30 may include a plurality of blades for cutting a cable. Specifically, the cutting system 30 may be configured to include a cutting main body 31, a first blade 32, a second blade 33, a hinge 34, and a warning indicator 36. The first blade 32 and the second blade 33 may perform as a receiver that detects a voltage of electrostatic charge generated in a cable when the cable is live.

The cutting main body 31 may form a space in which the first blade 32, the second blade 33, the hinge 34, and the warning indicator 36 are arranged. The cutting main body 31 is fixedly connected to the rotation portion 12 of the first main body 10 and may rotate along with the rotation of the rotation portion 12 to rotate the first blade 32 and the second blade 33.

The first blade 32 is arranged to face the second blade 33 and may be fixedly installed on the cutting main body 31. The first blade 32 may support one side of the cable during a cutting operation. If the cable is live, electrostatic charge may be generated before the first blade 32 supports one side of the cable. If electrostatic charge is generated in the cable, the first blade 32 may detect a voltage of the electrostatic charge. The voltage of the detected electrostatic charge of the cable may be transmitted to the live-line detection circuit 40 and the controller 50 through a live-line detection signal transmission circuit 42, and the above contents are described in detail with reference to FIG. 2.

The second blade 33 is arranged to face the first blade 32 and may be rotatably installed on the cutting main body 31. The second blade 33 may perform the function of cutting the cable together with the first blade 32 by rotating around the hinge 34 in the direction of the first blade 32 or in the direction opposite to the first blade 32 by being positioned on the other side of the cable, one side of which is supported by the first blade 32.

The hinge 34 is fixedly connected to the cutting main body 31, and the first blade 32 or the second blade 33 is rotatably connected thereto so that the hinge 34 may serve as an axis for the rotation of the second blade 33.

The first blade 32 and the second blade 33 may each detect a voltage of the electrostatic charge generated in the cable when the cable is live. The pair of blades may detect a voltage of the electrostatic charge formed from the cable when the cable is positioned between the first blade 32 and the second blade 33.

The warning indicator 36 may be placed on an outer surface of the cutting main body 31, and if it is determined that the cable for cutting is live, the warning unit 36 may output light or sound to warn the operator that the cable is live. The warning indicator 36 is illustrated as being arranged on the outer surface of the cutting main body 31, but is not limited thereto, and may be installed in other configurations of the cutting system 30 where the operator may intuitively check the warning, or in at least one of the first main body 10 and the second main body 20. In the present disclosure, an implementations in which multiple warning indicators 36 are installed for one cutter device 100 is illustrated, but a single warning indicator 36 may be installed.

FIG. 2 is a diagram schematically showing examples of internal components of a cutter according to some implementations. In FIG. 2, together with FIG. 1, a process of transmitting a live-line detection signal and a process of supplying power to each component inside the cutter device 100. The cutter device 100 may include a power supply unit (circuit) 60 placed within the second main body 20, the live-line detection circuit 40, the controller 50, and a motor 120 located within the first main body 10.

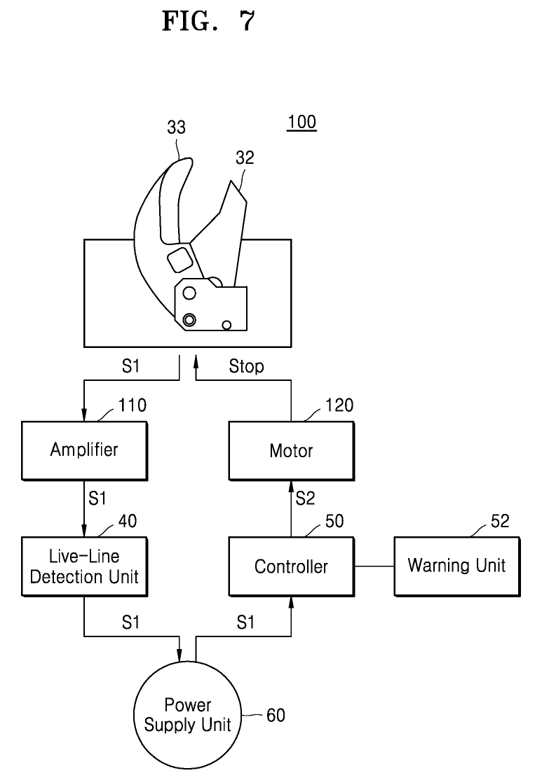

In some implementations, the cutter device 100 may include a live-line detection signal transmission unit (circuit) 42 that transmits a signal of the corresponding electrostatic voltage when the voltage of the electrostatic charge is detected from the cutting system 30. In some implementations, the signal of the electrostatic voltage may correspond to the live-line detection signal and may be amplified by an amplifier circuit 110 shown in FIG. 7. More specific details regarding this content are described with reference to FIG. 7.

The live-line detection signal transmission circuit 42 may not only transmit the signal of the electrostatic voltage, but may also serve as a passage for transmitting power. Hereinafter, the transmission process of a first signal S1, which is the signal of the electrostatic voltage, will be described.

The first blade 32 and the second blade 33 included in the cutting system 30 may detect a voltage of the electrostatic charge generated in the cable. In some implementations, the detection of the electrostatic voltage by the first blade 32 and the second blade 33 may be performed by a charging induction method. That is, even when the cable and the first blade 32 and the second blade 33 do not physically contact each other, electrostatic charge may be generated, and the voltage of the generated electrostatic charge may be transmitted to the first blade 32 and the second blade 33.

A signal of the electrostatic charge voltage is not transmitted to the live-line detection signal transmission circuit 42 only when it is generated from both the first blade 32 and the second blade 33, but the signal may also be transmitted when the electrostatic charge voltage is detected from at least one of the first blade 32 and the second blade 33. Accordingly, even when at least one of the first blade 32 and the second blade 33 is in a non-operating state, that is, when it is not performing its role as a receiver, it is possible to detect whether the cable is live. More specifically, the first blade 32 and the second blade 33 may be configured to receive electrostatic voltage independently of whether the other blade is operating.

A first signal S1* detected at the cutting system 30 may be transmitted to the live-line detection circuit 40 and the controller 50 through the live-line detection signal transmission circuit 42. The live-line detection signal transmission circuit 42 may be electrically connected to the grounding circuit 14, and thus, the cutting system 30 may form an electrically closed loop with the ground.

The live-line detection circuit 40 may receive the electrostatic voltage signal transmitted from the live-line detection signal transmission circuit 42, and when the signal is analyzed to determine that the cable is in a live state, the controller 50 may be configured to cut off the power supplied to the cutting system 30. More specifically, the controller 50 may send a second signal S2, which is a power cutoff signal, to the motor 120, and the motor 120 that receives the second signal S2 stops operating. As a result, when the motor 120 stops, the operation of the cutting system 30 may also stop.

In some implementations, a path through which the controller 50 receives the first signal S1 and a path through which the controller 50 transmits the second signal S2 may be configured differently. By transmitting and receiving signals through different paths in this way, interference between the first signal S1 and the second signal S2 may be prevented.

The power supply circuit 60 included in the second main body 20 may independently supply power to the controller 50 and the cutting system 30. In some implementations, first power PWR1 may be supplied to the controller 50 and the live-line detection circuit 40, and second power PWR2 may be supplied to the motor 120 that drives the cutting system 30. Additionally, the motor 120 supplied with the second power PWR2 may supply third power PWR3 to the cutting system 30, and at this time, voltages of the second power PWR2 and the third power PWR3 may be almost the same or similar.

In some implementations, the first power PWR1 and the second power PWR2 may have different voltages, and the first power PWR1 and the third power PWR3 may also have different voltages. In this case, the voltage of the first power PWR1 input to the controller 50 may be less than the voltage input to the motor 120 and the cutting system 30.

The controller 50 and the cutting system 30 operated by the motor 120 may each independently receive power from the power supply circuit 60. That is, because the power supplied to the controller 50 and the cutting system 30 is supplied independently from each other, the power supply of each may not affect the power supply of the other. Due to this configuration, noise generated during the operation of the cutting system 30 may not affect the controller 50.

In some implementations, even if power supplied to the motor 120 and the cutting system 30 is cut off, the power supplied to the controller 50 and the live-line detection circuit 40 may be maintained. In addition, if the controller 50 is continuously supplied with the first power PWR1 and a live-line is detected, the second signal S2 may be transmitted to the motor 120 to stop the operation of the motor 120.

In addition, the controller 50 may cut off the second power PWR2 supplied to the motor 120 by transmitting a power supply stop signal to the power supply circuit 60. At the same time, the third power PWR3 supplied to the cutting system 30 may also be cut off, thereby stopping the operation of the cutting system 30.

In this way, the first power PWR1 may be continuously supplied to the controller 50 regardless of whether the power supplied to the motor 120 and the cutting system 30 is cut off.

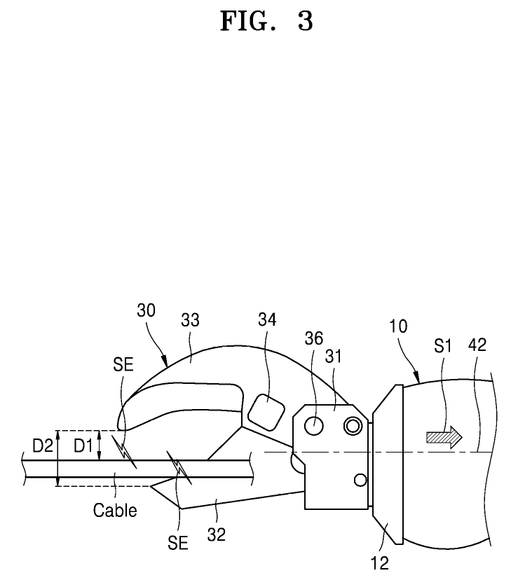

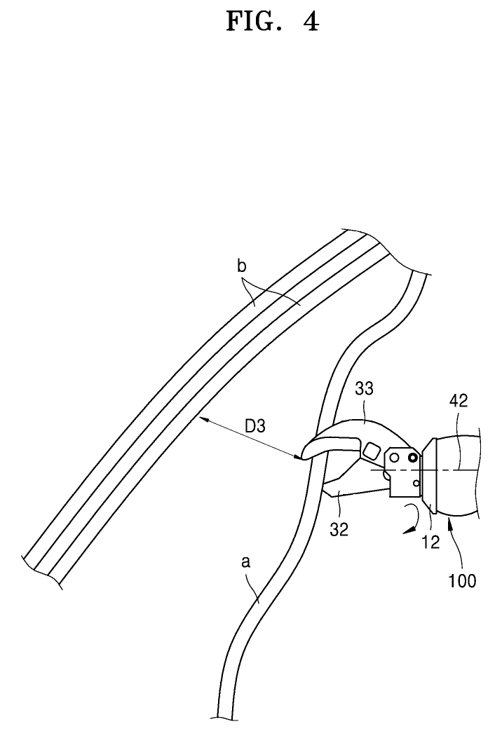

FIG. 3 is a diagram for explaining an example of an operation state of the cutter device 100 according to some implementations, and FIG. 4 is a diagram for explaining an example of a function of the cutter device 100 according to some implementations.

FIG. 3 is explained with reference to FIGS. 1 and 2, and repeated explanations are omitted. In FIG. 3, a process of cutting a cable by the cutting system 30 is illustrated. When the cable is in a live state, an electrostatic charge SE is generated in at least one of the first blade 32 and the second blade 33, which may cause an electrostatic induction phenomenon. Accordingly, the electrostatic charge SE may be simultaneously induced in each of the first blade 32 and the second blade 33. A method of inducing electrostatic charges SE in the cable by the first blade 32 and the second blade 33 may be implemented by an electrostatic induction method. In some implementations, the charging induction method may correspond to a method that utilizes a phenomenon in which an object is electrically charged from the outside even when it does not directly contact the object.

The electrostatic induction method may be performed first on the blade that is closer to the cable among the first blade 32 and the second blade 33. In addition, a distance by which the cable is separated from the first blade 32 and the second blade 33 may be defined as a first distance D1, and a distance by which the first blade 32 and the second blade 33 are separated from each other may be defined as a second distance D2. The electrostatic induction method may occur only when the first distance D1 is closer than the second distance D2. That is, in an environment where multiple cables exist, the electrostatic induction method may be applied only to the cable on which cutting is to be performed using the cutting system 30, and the electrostatic induction method is not applied to other cables on which cutting is not to be performed, and thus, the electrostatic charge SE may be detected only for the cable on which cutting is actually to be performed.

In some implementations, the voltage magnitude of the electrostatic charge SE generated when the cable Cable is located between the first blade 32 and the second blade 33 and the first distance D1 is less than the second distance D2 may be set to a preset threshold value. Also, the controller 50 may determine that the cable Cable is in a live state when the voltage magnitude of the electrostatic charge SE is greater than or equal to the preset threshold value. However, even while the cutting operation is in progress, there may be a possibility that electrostatic charge SE generated in another cable Cable that is not cut may be detected by at least one of the first blade 32 and the second blade 33. However, considering the distance between the cable Cable that is not cut and the cutter 100, the voltage magnitude of the electrostatic charge SE generated in the cable Cable that is not cut may be less than the preset threshold value, and thus, the cable Cable that is actually cut and the cable that is not cut may be distinguished.

In FIG. 4, there is a first cable a where cutting is actually performed, and a second cable b which is another cable where cutting is not performed is illustrated. There may be multiple second cables b. The first cable a corresponds to a single cable unless the cutting system 30 cuts multiple cables Cables. A distance between the first blade 32 and the second blade 33 to the second cable b corresponds to a third distance D3. The third distance D3 may be greater than the first distance D1 and the second distance D2. Therefore, because the third distance D3 is greater than the first distance D1, the electrostatic charge SE for the second cable Cable located at the third distance D3 is not detected by the electrostatic induction method.

As a result, even if the first cable a is inactive and the second cable b is active, the voltage of the electrostatic charge SE by the second cable b is not detected by the first blade 32 and the second blade 33, and thus, whether or not the first cable a is inactive may be accurately detected by the first blade 32 and the second blade 33.

In addition, when a voltage of electrostatic charge SE generated from the cable is received from at least one of the first blade 32 and the second blade 33, the first signal S1 is transmitted through the live-line detection signal transmission circuit 42, and ultimately the operation of the cutting system 30 is stopped. Therefore, the first blade 32 and the second blade 33 may independently receive the voltage of electrostatic charge SE.

That is, even if the first blade 32 does not operate, the second blade 33 may receive the voltage of electrostatic charge SE, and conversely, even if the second blade 33 does not operate, the first blade 32 may receive the voltage of electrostatic charge SE. In this way, the first blade 32 and the second blade 33 are configured to receive the voltage of electrostatic charge SE regardless of whether or not the other blades are operated. Therefore, even in a state when the first blade 32 is not performing its role as a receiver, if the second blade 33 operates normally, it is possible to clearly determine whether or not the cable is live.

Conversely, even in a state when the second blade 33 is not performing its role as a receiver, if the first blade 32 operates normally, it is possible to improve the reliability of detecting whether or not the cable is live.

In addition, in some implementations, since each of the first blade 32 and the second blade 33 may perform its role as an antenna without additional components (e.g., without a separate antenna for detecting a magnetic field exposed to the outside and detecting whether the cable is live) , the life of the cutter device 100 may be further improved.

Hereinafter, the rotational motion for cutting the cutting system 30 will be described in detail.

In FIG. 4, the cutter device 100 may determine that the first cable Cable is in a non-live state if the voltage of the electrostatic charge is not detected by at least one of the first blade 32 and the second blade 33.

That is, if the first cable a, which is the cable that the operator wants to cut, is placed between the first blade 32 and the second blade 33, each of the pair of blades placed on both sides of the first blade 32 is spaced apart from the first cable a by the same distance, thereby detecting the voltage of the electrostatic charge SE generated from the first cable a. Therefore, the magnitude of the voltage of the electrostatic charge SE detected from the pair of blades must be substantially the same.

However, if the distance between the first cable Cable and each of the blades between the pair of blades is different, the magnitude of the voltage of the electrostatic charge SE detected from each of the pair of blades may be different from each other. However, in some implementations, whether or not the cable is live is determined based only on whether electrostatic charge SE is detected, and the voltage magnitude of the electrostatic charge SE is not an important factor in detecting whether the cable is live.

If it is determined to be in a non-live state, the cutter device 100 may supply power to the cutting system 30 to rotate the second blade 33 to cut the first cable a.

At this time, the cutter device 100 may rotate the rotation portion 12 so that the first blade 32 and the second blade 33 are placed at orthogonal position to the first cable a.

That is, in a work environment when new electrical equipment is installed or existing electrical equipment is repaired or removed, an environment in which the worker may cut the cable in a correct posture may not be provided. As a result, the worker may easily position the cable between the first blade 32 and the second blade 33, but it may be difficult to position the first blade 32 and the second blade 33 exactly orthogonal to the cable a.

Accordingly, the cutter device 100 may control the rotation portion 12 to correct the positions of the first blade 32 and the second blade 33 so that the cable is cut while the first blade 32 and the second blade 33 are perpendicular to the cable a.

FIG. 5 is a conceptual diagram showing an example of a detailed process of supplying power to the cutter device 100 according to some implementations. In FIG. 5, the power supply circuit 60 and other components connected to the power supply circuit 60 is illustrated. The power supply circuit 60 may include a power separation and a decompression circuit 61 configured to prevent noise generation when supplying power to a controller. In FIG. 5, the controller may be configured to include a micro-control unit (MCU) 51.

A switch circuit 61_1, a battery circuit 61_2, and a power separation circuit 61_3 may constitute the power separation and decompression circuit 61. The switch circuit 61_1 may perform a role in determining whether power is input. The switch circuit 61_1 may correspond to the button portion 13 illustrated in FIGS. 1 and 2. When the switch circuit 61_1 operates, the battery circuit 61_2 having a first voltage may receive a signal from the switch circuit 61_1 to supply a voltage.

The switch circuit 61_1 is connected to the battery circuit 61_2, and the power separation circuit 61_3 and the motor 120 may each be connected in parallel to the battery circuit 61_2. In addition, the power separation circuit 61_3 and the motor 120 connected in parallel to the battery circuit 61_2 may independently receive power from the battery circuit 61_2. Each of a live-line detection integrated circuit (IC) 41 and the MCU 51 is connected in parallel to the power separation circuit 61_3, and the cutting system 30 may be directly connected to the motor 120.

A voltage of the battery circuit 61_2 itself may correspond to a first voltage V1, but the voltage may be first reduced in the battery circuit 61_2 and transmitted to another component, or the first voltage V1 may be transmitted as is to another component. In some implementations, the battery circuit 61_2 may supply the first voltage V1 to the motor 120 when the switch circuit 61_1 operates. In some implementations, the battery circuit 61_2 may supply a second voltage V2 to the power separation circuit 61_3 when the switch circuit 61_1 operates. At this time, the second voltage V2 may be a voltage less than the first voltage V1. In some implementations, the first voltage V1 may be about 18 V, and the second voltage V2 may be about 12 V.

The power separation circuit 61_3, which receives the second voltage V2 from the battery circuit 61_2, may transmit a third voltage V3 to each of the live-line detection IC 41 and the MCU 51. The live-line detection IC 41 of FIG. 5 is a configuration included in the live-line detection circuit 40 of FIG. 2 and may correspond to a PCB board. The live-line detection circuit 40 may additionally include a configuration other than the live-line detection IC 41. The third voltage V3 may be a voltage less than the second voltage V2. In some implementations, the third voltage V3 may be about 5 V.

In addition, the power separation circuit 61_3 is a system that converts the second voltage V2, which is the power supplied to each of the live-line detection IC 41 and the MCU 51, into the third voltage V3, and may prevent noise generated from the live-line detection IC 41 from affecting the MCU 51. Accordingly, by the power separation circuit 61_3, the controller 50 including the MCU 51 may perform a live-line detection function with improved reliability without being affected by noise, and may smoothly perform a control operation to stop the operation of the cutting system 30. In some implementations, the controller 50 may additionally include a configuration other than the MCU 51.

The power separation and decompression circuit 61 may perform a function of supplying a decompressed voltage to each of the live-line detection circuit 40 and the controller 50 for an input voltage, and a function of separating and supplying a voltage to each of the live-line detection circuit 40 and the controller 50. In the related art, when power of the cutter itself was used, overvoltage could be supplied to the controller, or difficulties may occur in the process of detecting whether the cable is live due to noise generation. However, in some implementations, by independently supplying the third voltage V3 lower than the first voltage V1 to the MCU 51 through the power separation and decompression circuit 61, the controller 50 including the MCU 51 may be protected from overvoltage, and noise introduced from the battery of the cutter may be effectively reduced.

The first voltage V1 input from the battery circuit 61_2 to the motor 120 may be transmitted to the cutting system 30 to drive the cutting system 30. The power supply circuit 60 may include a switch contact circuit 64 and a live-line detection operation relay circuit 65. The switch contact circuit 64 and the live-line detection operation relay circuit 65 may be directly connected to the switch circuit 61_1. The connection line for the live-line detection operation relay circuit 65, the switch contact circuit 64, and the switch circuit 61_1 may perform a role of transmitting a signal. The live-line detection operation relay circuit 65 may be configured to finally transmit a signal to the switch circuit 61_1 to perform an operation after live-line detection.

The power supply circuit 60 may include a power maintain signal circuit 62, a cutter power down detection circuit 63, and the main board circuit 66. The main board circuit 66 may be configured to perform a function of analyzing a signal value for the voltage of the electrostatic charge SE, as well as a control function.

The power maintain signal circuit 62 and the cutter power down detection circuit 63 may be electrically connected to the MCU 51. The MCU 51 may be booted by receiving power from the battery circuit 61_2. After the MCU 51 is booted, a power maintain signal may be applied to the power maintain signal circuit 62. The power maintain signal circuit 62 may be configured to keep the power of other components on without turning off even when a live-line is detected and the power of the cutter is turned off. That is, when a live-line is detected, the MCU 51 may transmit an off signal and an on signal simultaneously. At this time, the on signal may be transmitted to the power maintain signal circuit 62, and the off signal may be transmitted to the motor 120.

If the cutter device 100 is not used for a long time, the entire cutter device 100 may be powered off, and the off-state of the cutter device 100 may be detected by the cutter power down detection circuit 63. The cutter power down detection circuit 63 detects the power of the main board circuit 66, and when the power of the main board circuit 66 is powered off, all components performing the live-line detection function, including the live-line detection IC 41 and the live-line detection operation relay circuit 65, may be configured to be turned off.

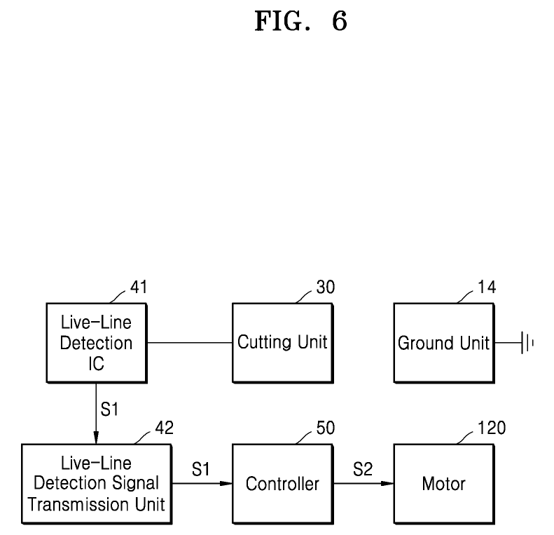

FIG. 6 is a conceptual diagram showing an example of a process of transmitting a live signal of the cutter device according to some implementations. In FIG. 6, together with FIG. 5, the cutting system 30 may include a plurality of blades as described above, and each blade may perform the role of a detector that detects static charge while also performing the function of an antenna. That is, the blades included in the cutting system 30 have not only a simple cutting function but also a function to detect whether the cable is live, and in this way, they may perform the role of identifying the electrical status of the cable.

If a voltage of electrostatic charge SE is detected in the cutting system 30, a voltage signal corresponding to the electrostatic charge may be transmitted to the live-line detection IC 41. Additionally, the voltage signal of the electrostatic charge detected in the cutting system 30 may be amplified in an amplifier circuit 110 (refer to FIG. 7) and then transmitted to the live-line detection IC 41. That is, because the signal directly detected in the cutting system 30 may have a low voltage, the signal may be amplified through the amplifier circuit 110 to detect the signal more clearly and increase reliability. Accordingly, the amplified signal reaches the live-line detection IC 41, and based on this, whether or not the cable is live may be determined more precisely.

The amplifier circuit 110 may be placed between the cutting system 30 and the live-line detection IC 41, and may perform a role in minimizing loss that may occur during the signal transmission process by strengthening the signal intensity. Using the amplifier circuit 110 in this way may perform a more stable live-line detection function and improve the reliability of the cutter.

The live-line detection IC 41 can generate a first signal S1, which is a signal indicating that the cable is live, and transmit the first signal S1 to the live-line detection signal transmission circuit 42. The first signal S1 shown in FIG. 6 may be interpreted as the same signal as the first signal S1 shown in FIG. 2 and FIG. 3, and becomes an important criterion for determining whether or not there is a live-line.

The live-line detection signal transmission circuit 42 may transmit the first signal S1 received from the live-line detection IC 41 to the controller 50. The controller 50 analyzes the received first signal S1 to determine whether to continue the cutting operation. If the controller 50 determines that the cable is live through the first signal S1, the controller 50 may send a second signal S2 to the motor 120 to stop the operation of the cutting system 30.

The second signal S2 is a different signal from the first signal S1 and serves to transmit a command to stop the operation of the cutter 100. The second signal S2 shown in FIG. 6 may be viewed as a signal that has the same role as the second signal S2 shown in FIG. 2, and may perform an important function of allowing the cutter to immediately stop operation when a live state is detected.

In some implementations, the first signal S1 transmitted from the live-line detection signal transmission circuit 42 may also be received by the power supply circuit 60. After receiving the first signal S1, the power supply circuit 60 may transmit a signal to the controller 50 again to cut off the power supplied to the motor 120. That is, the power supply circuit 60 may not only simply supply power, but also cut off the power based on the live detection signal to ensure the safety of the cutter device 100.

Through this process, when an electrostatic voltage is detected in the cutting system 30, the electrostatic voltage is amplified through the amplifier circuit 110, and the live-line detection IC 41 finally analyzes the signal to determine whether or not there is a live line. Thereafter, the first signal S1 generated in the live-line detection IC 41 is transmitted to the controller 50 through the live-line detection signal transmission circuit 42, and the controller 50 transmits a second signal S2 to stop the operation of the motor 120 as needed.

In addition, the first signal S1 transmitted from the live-line detection signal transmission circuit 42 may also be transmitted to the power supply circuit 60, through which the power supply circuit 60 may take action to cut off the power of the motor 120. In this process, the power supply circuit 60 may not only simply cut off the power to the motor 120, but also transmit a signal to the controller 50 as needed to stop the overall operation of the cutter device 100.

As a result, the cutter has a series of protection functions that detect whether the cable is live and safely perform cutting operations based on the protection functions. In particular, because the blade itself performs the function of detecting electrostatic charge, accurate live detection is possible without a separate external detection device, thereby improving the life of the cutter and ensuring the safety of the operator.

Therefore, the cutter has a structure that may quickly detect the electrical status of a cable and prevent accidents through an immediate cut-off signal when necessary, and thus, it may be effectively utilized in various electrical work environments.

FIG. 7 is a conceptual diagram showing an example of a process of receiving a live signal and stopping the operation of a cutting unit of a cutter according to some implementations. In FIG. 7, the cutter device 100 may be configured to include the first blade 32, the second blade 33, the amplifier circuit 110, the warning indicator 52 (which may correspond to the warning indicator 36 described in FIGS. 1 to 6), the controller 50, the motor 120, the live-line detection circuit 40, and the power supply circuit 60. Some components of the cutter device 100 are merely functionally distinct elements, so in an actual physical environment, two or more components may be integrated with each other, or one component may be implemented separately. That is, rather than a specific component existing alone, multiple functions may be integrated and arranged within a single module or hardware, and may be implemented in a separate form as needed.

In describing with respect to each component, the first blade 32 and the second blade 33 may detect a voltage of static electricity through the electrostatic induction method. The electrostatic induction method utilizes the principle that static electricity is induced and a voltage is generated in a specific object even without direct physical contact, and by utilizing this characteristics, it is possible to detect whether a cable is live before the blade of the cutter comes into contact with the cable.

Next, the amplifier circuit 110 may receive the first signal S1, which is a signal representing the voltage of static electricity detected by at least one of the first blade 32 and the second blade 33, and amplify the first signal S1.

Specifically, the amplifier circuit 110 may amplify the first signal S1, which is a signal for an electrostatic voltage formed from the cable, using an analog amplifier (Operational Amplifier (OP-AMP)). That is, the amplifier circuit 110 may amplify the electrostatic voltage formed from the cable to a predetermined preset value and transmit the amplified signal to the power supply circuit 60 through the live-line detection circuit 40. The live-line detection circuit 40 that receives the amplified first signal S1 may transmit the amplified first signal S1 back to the power supply circuit 60. In some implementations, the process of transmitting the first signal S1 may be performed through the live-line detection signal transmission circuit 42 described with reference to FIG. 6.

The power supply circuit 60 may receive the first signal S1 and transmit the first signal S1 to the controller 50. The controller 50 may determine whether the cable is live based on the electrostatic voltage signal amplified by the amplifier circuit 110. If the cable is determined to be live, the controller 50 may cut off the power supplied to the cutting circuit 30 including the first blade 32 and the second blade 33.

Specifically, the controller 50 may determine that the cable is live if either the first blade 32 or the second blade 33 detects an electrostatic voltage. For example, when a worker places a cable between the first blade 32 and the second blade 33 to perform a cutting operation, an electrostatic charge may be generated in the cable, and an electrostatic voltage generated at this time may be transmitted to the controller 50 through the live-line detection signal transmission circuit 42. The controller 50 may initially determine that the cable is in a live line state at the moment the controller 50 detects the electrostatic voltage. On the other hand, if the electrostatic voltage is not detected by the first blade 32 and the second blade 33, the controller 50 may determine that the cable is not live.

In addition, as an example, the controller 50 that has received the first signal S1 may finally transmit a second signal S2 to the motor 120 to stop the operation of the cutting system 30 including the first blade 32 and the second blade 33.

The motor 120 that has received the second signal S2 may stop the operation. In addition, the power supply circuit 60 that has received the first signal S1 may cut off the power supplied to the motor 120. However, because only the signal transmission process is shown in FIG. 7, the process of cutting off the power supplied to the motor 120 by the power supply circuit 60 is omitted.

Next, the warning indicator 36 may output one or more of light, sound, and vibration when an electrostatic voltage is detected from the cable by at least one of the first blade 32 and the second blade 33.

Specifically, the warning indicator 36 may be configured to include one or more of a light-emitting element for outputting light, a speaker for outputting sound, and a vibration motor for outputting vibration. In addition, the warning indicator 36 may output one or more of light, sound, and vibration in a specific pattern according to the user's setting when the cable is determined to be in a live state by the controller 50.

The warning indicator 36 may include a light-emitting element for outputting light, and the light-emitting element may be configured to emit light of different wavelengths depending on whether the cable is in a live state or a non-live state. For example, when the cable is in a live state, the light-emitting element may emit red light, and when the cable is in a non-live state, the light-emitting element may emit green light.

Because the color and wavelength of the light emitted by the light-emitting element may be easily recognized by the user, a worker may perform the cable cutting work more quickly and safely. For example, the controller 50 may output red light when electrostatic charge is detected in at least one of the first blade 32 and the second blade 33. In addition, the controller 50 may output a "beep" sound along with a voice guidance such as "the cable has been confirmed to be in a non-live state" when the cable is determined to be in a non-live state.

At this time, the controller 50 may also output the "beep" sound by varying a pitch depending on the size of the detected electrostatic charge voltage. That is, the controller 50 may support the worker to be able to more intuitively identify the status of the cable by increasing the frequency of the warning sound as the voltage increases or outputting the warning sound in a specific pattern.

Through this function, the worker may quickly check whether the cable to be cut is in a non-live state, and also, additionally check if other cables in the vicinity are in a live state, which may help prevent safety accidents.

Accordingly, the cutter has a function to detect whether the cable is live in real time and immediately stop the operation of the cutting unit if necessary to ensure the safety of the worker, and through this operation, the reliability and safety of the work may be greatly improved.

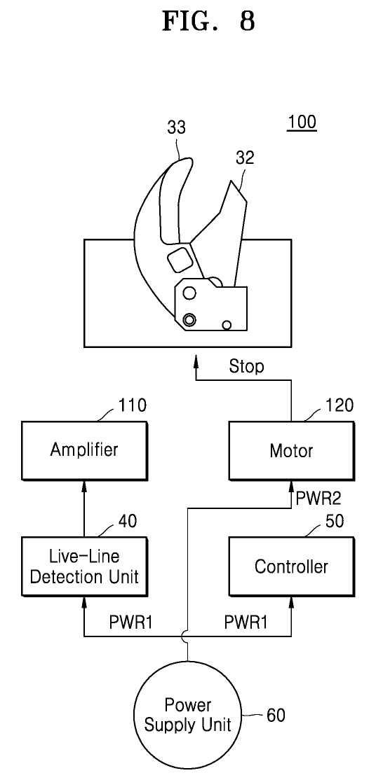

FIG. 8 is a conceptual diagram showing an example process of supplying power to a cutter according to some implementations. In FIG. 8, the power supply circuit 60 may supply power to each component of the cutter device 100 capable of detecting a live-line according to the control of the controller 50. At this time, if the controller 50 determines that the cable to be cut is live, the power supply circuit 60 may cut off power supplied to the cutter device 100 including the first blade 32 and the second blade 33. That is, if the cable to be cut is detected as live, the cutter device 100 is configured to immediately stop its operation in order to protect the user's safety.

The power supply circuit 60 may supply the first power PWR1 to each of the live-line detection circuit 40 and the controller 50. In addition, the power supply circuit 60 may supply the second power PWR2 to the motor 120, and the two powers PWR1 and PWR2 may be supplied independently. That is, the first power PWR1 is independently supplied to the live-line detection circuit 40 and the controller 50, and the second power PWR2 is independently supplied to the motor 120, and thus, it may be designed so that noise generated from a specific component may not affect other components.

For example, although the first power PWR1 is supplied to the controller 50, if the controller 50 detects a live signal, the second power PWR2 may not be supplied to the motor 120. By supplying the power independently in this way, noise generated due to the operation of the motor 120 may not affect the first power PWR1 supplied to the live-line detection unit 40 and the controller 50. As a result, the cutter device 100 may be designed so that live-line detection may be performed smoothly without electrical interference due to motor operation.

In addition, the live-line detection circuit 40 that has received the first power PWR1 may transfer some of the first power PWR1 to the amplifier circuit 110. That is, the amplifier circuit 110 performs the role of amplifying the electrostatic charge detection signal, and, for this purpose, the amplifier circuit 110 may operate by receiving a separate power supply.

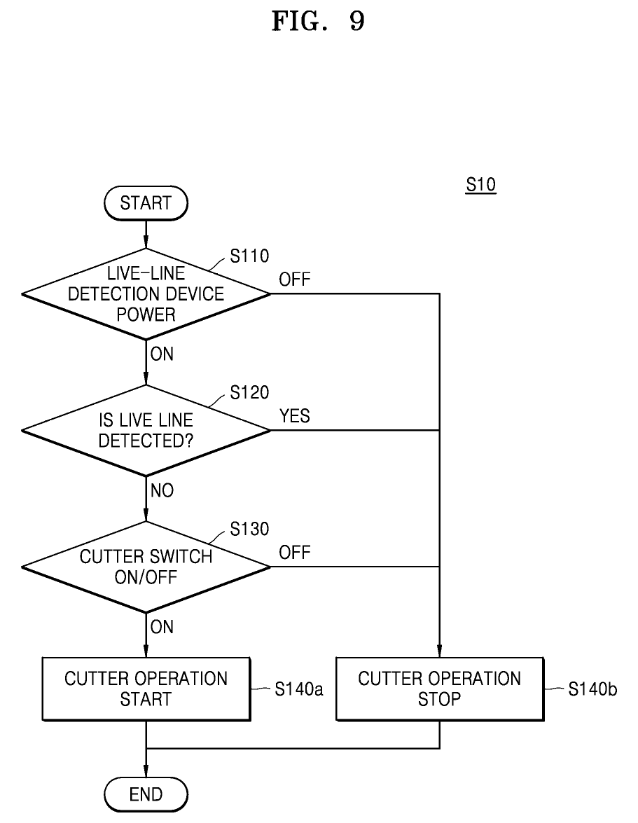

FIG. 9 is a flowchart showing an example of a control method of a cutter according to some implementations. In FIG. 9, the control method S10 of the cutter device may include an operation of turning on or off power of a live-line detection device, and this operation may correspond to operation S110. The live-line detection device mentioned with reference to FIG. 9 may correspond to the live-line detection circuit 40 illustrated in FIG. 2.

If the power of the live-line detection device is turned off in operation S110, the operation of the cutter device may be stopped by operation S140b. Here, the cutter device may be regarded as a device having the same structure as the cutter device 100 described with reference to FIGS. 1 to 8.

The control method S10 of the cutter device may include operation S120 for determining whether a live-line is detected, which is performed after operation S110, if the power of the live-line detection device is turned on in operation S110. Operation S120 for detecting whether a cable is live may be performed by the first blade 32, the second blade 33, the live-line detection circuit 40, and the controller 50 illustrated in FIG. 2. If a live-line is detected in operation S120, operation S140b described above is performed, and accordingly, the operation of the cutter device may be automatically stopped.

The control method S10 of the cutter device may include operation S130 for controlling on/off of a switch of the cutter device, which is performed after operation S120, if a live-line is not detected in operation S120. Here, the switch of the cutter device may correspond to the switch circuit 61_1 illustrated in FIG. 5.

If the switch of the cutter device is in an off-state at operation S130, operation S140b described above is performed, and accordingly, the operation of the cutter device may be stopped. On the other hand, the control method S10 may additionally include operation S140a for starting the operation of the cutter if the switch of the cutter device is in the on-state at operation S130.

The process from operation S110 to operation S130 may be performed sequentially, and some operations may be performed simultaneously. However, each operation is performed in a set order, and a specific operation may not be skipped or performed in a reversed order.

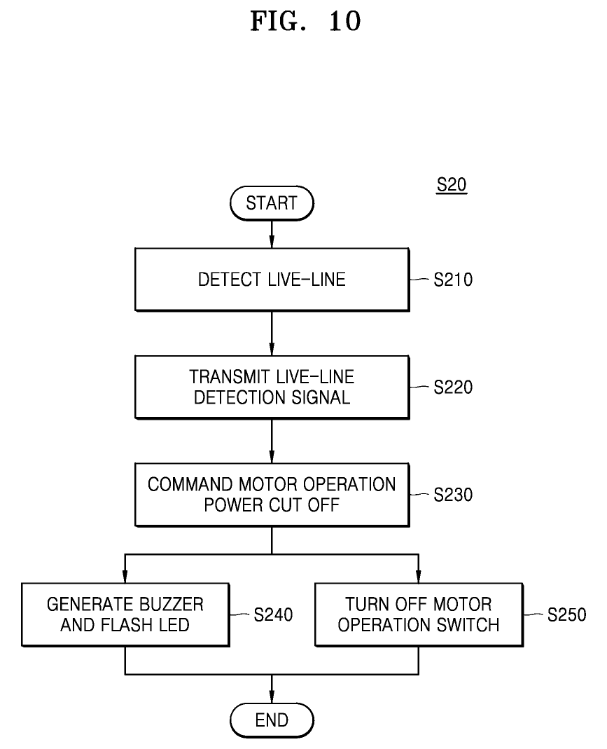

FIG. 10 is a flowchart showing an example of a control method of a cutter device when a live-line is detected according to some implementations. In FIG. 10, if a live-line is detected for a cable, a control method S20 of the cutter device may be performed. The control method S20 of the cutter device when a live line is detected may include operation S210 of detecting a live-line. Operation S210 for detecting whether the cable is live may be performed by the first blade 32, the second blade 33, the live-line detection circuit 40, and the controller 50 of FIG. 2.

The control method S20 of the cutter device when detecting a live-line may include operation S220 of transmitting a live-line detection signal if a live-line is detected in operation S210. This operation may be performed by the live-line detection signal transmission unit 42 of FIG. 2.

The process of the cutter device of FIG. 10 may include operation S230 for cutting off the power to stop the operation of the motor after operation S220. Operation S230 may be performed by the controller 50 of FIG. 2. In operation S230, the controller 50 may directly instruct the motor 120 to stop the operation, or may instruct the power supply circuit 60 to cut off the power supplied to the motor 120. Both methods may generate the same result of stopping the operation of the motor 120.

The process of the cutter device may include operation S240 for generating a buzzer and flashing an LED, which may be performed after operation S230, and operation S250 for stopping the motor operation.

At operation S240, a light-emitting element of the warning indicator 36 may emit red light and may also generate a buzzer sound. At operation S250, the motor operation switch is turned off, so that the cutter may be completely stopped.

As a result, the cutter may automatically detect if the cable is live and immediately stop the cutting operation, and may perform the function of notifying the worker of danger through a buzzer sound and an LED signal. Through this operation, the safety of the worker may be effectively secured, and accidents due to electrical hazards may be prevented in advance.

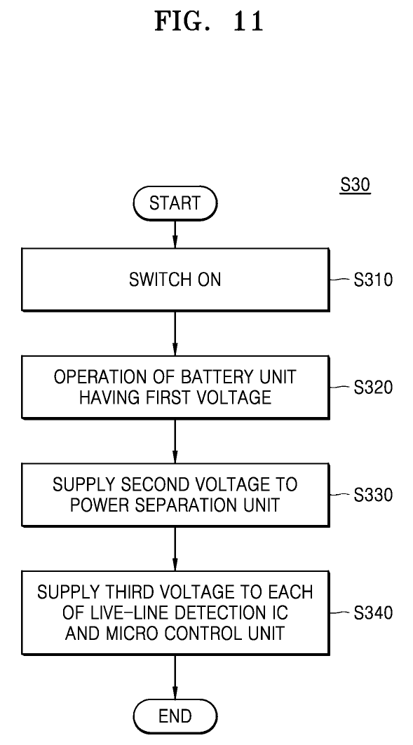

FIG. 11 is a flowchart showing an example of a process of supplying power to a cutter device according to some implementations. In FIG. 11, the process of supplying power to the cutter device is illustrated as process S30, and the process S30 may directly correspond to the flowchart of power flow within the power separation and decompression circuit 61 described with reference to FIG. 5. That is, the same concept as the power supply process described with reference to FIG. 5 is applied, and the flowchart of FIG. 11 may be viewed as a procedural summary of the power supply process.

Process S30 includes a series of procedures necessary to supply power to the cutter device, and specifically, may include operation S310 that switches the power of the switch circuit 61_1 described with reference to FIG. 5 to an on-state. The switch circuit 61_1 performs a role in controlling the power of the cutter device as a whole, and is the first operation that a user must go through when operating the cutter device.

After operation S310 is performed, operation S320 of operating the battery circuit having the first voltage described with reference to FIG. 5 may be performed subsequently. That is, in operation S320, the battery circuit 61_2, which is the power supply source of the cutter device, is activated, and thus, preparations for supplying power to the main components of the cutter device are achieved.

After operation S320 is completed, operation S330, which supplies a second voltage to the power separation circuit 61_3may be performed next. The power separation circuit 61_3performs an important role in preventing electrical interference by supplying independent power to each component of the cutter device. In particular, it may perform a function of independently maintaining the power supply path between the motor 120 and the controller 50 so that electrical noise that may occur due to the operation of the motor does not affect the signal detection of the controller 50 and the live-line detection circuit 40.

After operation S330 is performed, operation S340, which supplies a third voltage to each of the live-line detection IC and the MCU, may be performed. That is, in operation S340, separate power is supplied so that the live-line detection circuit 40 and the controller 50 may operate normally, and then, the safety function of the cutter device may be activated.

In this way, after the switch unit is activated in operation S310, the battery circuit 61_2operates in operation S320, a voltage is supplied to the power separation circuit 61_3through operation S330, and finally, the voltage is supplied to the live-line detection IC and MCU in operation S340, and thus, the power supply process of the cutter device may be completed sequentially.

In particular, because the process from operation S310 to operation S340 is a process performed between components connected in series, as seen in FIG. 5, it must be performed sequentially and may not be performed by skipping a specific operation or changing the order. In other words, in order for power to be supplied normally, each operation must be executed in sequence so that all functions of the cutter device may be guaranteed to operate normally.

While this disclosure contains many specific implementation details, these should not be construed as limitations on the scope of what may be claimed, equivalents thereof, as well as claims to be described later. Certain features that are described in this disclosure in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations, one or more features from a combination can in some cases be excised from the combination, and the combination may be directed to a subcombination or variation of a subcombination.

What is claimed is:

1. A cutter device comprising:
a cutting system configured to cut a cable, the cutting system including a first blade and a second blade configured to receive a voltage of electrostatic charge applied from the cable;
an amplifier circuit configured to amplify a signal for the voltage of electrostatic charge detected by the cutting system;
a live-line detection circuit configured to determine, based on the signal amplified by the amplifier circuit, that the cable is live;
a power supply circuit configured to supply power to the cutting system; and
a controller configured to, upon the cable being determined to be live by the live-line detection circuit, cut off power supplied to the cutting system.

2. The cutter device of claim 1, wherein the power supply circuit is configured to supply power to the controller and the cutting system.

3. The cutter device of claim 1,
wherein voltage of the electrostatic charge by the first blade and the second blade is detected based on electrostatic induction, and
wherein the controller is configured to, based upon the voltage of the electrostatic charge being received from at least one of the first blade or the second blade, cut off the power supplied to the cutting system.

4. The cutter device of claim 3,
wherein the electrostatic induction is based on one of the first blade and the second blade that is located closer to the cable, and
wherein the first blade and the second blade are configured to receive the voltage of the electrostatic charge independently from operation of each other.

5. The cutter device of claim 1, comprising:
a first main body connected to a lower portion of the cutting device,
wherein the first main body comprises:
a body portion configured to be grippable by a user;
a rotation portion that enables the cutting system to rotate;
a button portion configured to control operation of the cutting system; and
a grounding portion located near the button portion.

6. The cutter device of claim 5, comprising:
a live-line detection signal transmission circuit configured to transmit, to the live-line detection circuit, a signal relating to the voltage of the electrostatic charge detected by the first blade and the second blade,
wherein the live-line detection signal transmission circuit is electrically connected to the grounding portion.

7. The cutter device of claim 1,
wherein the first blade is fixedly installed and the second blade is positioned opposite to the first blade and is configured to be rotated by the controller, and
wherein the second blade is configured to be driven by a motor electrically connected to the power supply circuit.

8. The cutter device of claim 1,
wherein the power supply circuit includes a power isolation and decompression circuit configured to restrict noise generated between the power supply circuit and the controller, and
wherein the controller and the cutting system are independently connected to the power supply circuit.

9. The cutter device of claim 8,
wherein the power supply circuit includes a switch circuit, a battery circuit, and a power separation circuit,
wherein a magnitude of a first voltage of the battery circuit operated by the switch circuit is greater than a magnitude of a second voltage transmitted from the battery circuit to the power separation circuit,
wherein the cutter device includes:
a live-line detection integrated circuit (IC) included in the live-line detection circuit; and
a micro control circuit included in the controller, and
wherein a magnitude of a third voltage transmitted from the power separation circuit to each of the live-line detection IC and the micro control circuit is less than the magnitude of the second voltage.

10. The cutter device of claim 9,
wherein the switch circuit is connected to the battery circuit,
wherein the power separation circuit and a motor are connected in parallel with the battery circuit,
wherein the live-line detection IC and the micro control circuit are connected in parallel with the power separation circuit, and
wherein the cutting system is directly connected to the motor.

11. A cutter device comprising:
a cutting system configured to cut a cable, the cutting system including a first blade and a second blade configured to receive a voltage of electrostatic charge applied from the cable;
an amplifier circuit configured to amplify a signal for the voltage of electrostatic charge detected by the cutting system;
a live-line detection circuit configured to determine, based on the signal amplified by the amplifier circuit, that the cable is live;
a controller configured to cut off power supplied to the cutting system based upon the cable being determined to be live by the live-line detection circuit;
a first main body connected to a lower portion of the cutting system; and
a second main body disposed on a lower portion of the first main body and including a power supply circuit,
wherein the power supply circuit is configured to supply power to the cutting system and the controller, and
wherein a magnitude of a voltage of power supplied to the controller is less than a magnitude of power supplied to the cutting system.

12. The cutter device of claim 11,
wherein the voltage of the electrostatic charge by the first blade and the second blade is detected based on electrostatic induction without contact with the cable, and
wherein the controller is configured to cut off the power supplied to the cutting system based upon the voltage of the electrostatic charge being received from at least one of the first blade or the second blade.

13. The cutter device of claim 12,
wherein, based upon a distance by which the cable is spaced apart from the first blade and the second blade being defined as a first distance, and a distance by which the first blade and the second blade are spaced apart from each other being defined as a second distance, and upon the cable being located between the first blade and the second blade:
a magnitude of the voltage of the electrostatic charge generated based upon the first distance being less than the second distance is set as a threshold value, and
the controller is configured to determine that the cable is a live line based upon the magnitude of the voltage of the electrostatic charge being greater than or equal to the threshold value, and
wherein the first blade and the second blade are configured to receive the voltage of the electrostatic charge independently from operation of each other.

14. The cutter device of claim 11,
wherein the first main body comprises:
a body portion configured to be grippable by a user;
a rotation portion configured to enable the cutting system to rotate;
a button portion configured to control operation of the cutting system; and
a grounding portion located near the button portion, and
wherein the cutter device comprises a live-line detection signal transmission circuit configured to transmit a signal relating to the voltage of electrostatic charge detected by the first blade and the second blade,
wherein the live-line detection signal transmission circuit is electrically connected to the grounding portion, and
wherein the cutting system and an electrical ground form an electrically closed loop.

15. The cutter device of claim 14,
wherein the first blade is fixedly installed, and the second blade is positioned opposite to the first blade and is configured to be rotated by a rotation portion controlled by the controller, and
wherein the second blade is configured to be driven by a motor electrically connected to the power supply circuit.

16. The cutter device of claim 11,
wherein the power supply circuit includes a power separation and decompression circuit configured to restrict noise generated between the power supply circuit and the controller,
wherein the controller and the cutting system are each independently connected to the power supply circuit,
wherein the power separation and decompression circuit comprises a switch circuit, a battery circuit, and a power separation circuit that are electrically connected to each other, and
wherein a magnitude of a first voltage of the battery circuit operated by the switch circuit is greater than a magnitude of a second voltage transmitted from the battery circuit to the power separation circuit.

17. The cutter device of claim 16, comprising:
a live-line detection integrated circuit (IC) included in the live-line detection circuit; and
a micro control circuit included in the controller ,
wherein the live-line detection IC and the micro control circuit are electrically connected to the power separation circuit, and
wherein a magnitude of a third voltage transmitted from the power separation circuit to the live-line detection IC and the micro control circuit is less than the magnitude of the second voltage.

18. The cutter device of claim 11,
wherein the controller is configured to:
determine that the cable is in a live state, based upon a signal relating to the voltage of the electrostatic charge being detected by the first blade and the second blade, and
determine that the cable is in a non-live state, based upon a signal for the voltage of the electrostatic charge not being detected by the first blade and the second blade,
wherein the cutter device includes a warning indicator configured to output at least one warning signal among light, sound, and vibration based upon the controller determining that the cable is in a live state,
wherein the warning indicator includes a light-emitting element configured to output the light, and
wherein the light-emitting element is configured to emit the light having different wavelengths in each of the live state and the non-live state of the cable.

19. A cutter device comprising:
a cutting system configured to cut a cable and including a first blade and a second blade configured to receive a voltage of electrostatic charge applied from the cable;
an amplifier circuit configured to amplify a signal of the voltage of electrostatic charge detected by the cutting system;
a live-line detection circuit configured to determine, based on the signal amplified by the amplifier circuit, that the cable is live;
a controller configured to cut off power supplied to the cutting system based upon the cable being determined to be live by the live-line detection circuit;
a first main body connected to a lower portion of the cutting system;
a second main body on a lower portion of the first main body and including a power supply circuit;
a live-line detection integrated circuit (IC) included in the live-line detection circuit; and
a micro control circuit included in the controller,
wherein the power supply circuit includes a power separation and decompression circuit configured to supply power to the cutting system and the controller, respectively, and configured to restrict noise generated between the power supply circuit and the controller,
wherein the controller and the cutting system are each independently connected to the power supply circuit,
wherein the power separation and decompression circuit comprises a switch circuit, a battery circuit, and a power separation circuit that are electrically connected to each other, and a magnitude of a first voltage of the battery circuit operated by the switch circuit is greater than a magnitude of a second voltage transmitted from the battery circuit to the power separation circuit, and
wherein the live-line detection IC and the micro control circuit are electrically connected to the power separation circuit, and a magnitude of a third voltage transmitted from the power separation circuit to each of the live-line detection IC and the micro control circuit is less than the magnitude of the second voltage.

20. The cutter device of claim 19,
wherein the power supply circuit includes
a power maintain signal circuit electrically connected to the micro control circuit; and
a cutter power down detection circuit, and
wherein the controller is configured to, based upon the controller determining that the power supply circuit is in a live state, apply power to the power maintain signal circuit.
